(19) United States
(12) Patent Application Publication
(10) Pub. No.: US 2024/0213681 A1
(43) Pub. Date: Jun. 27, 2024

(54) MOBILE DEVICE FOR REDUCING SPECIFIC ABSORPTION RATE

(71) Applicant: Acer Incorporated, New Taipei City (TW)

(72) Inventors: Kun-Sheng CHANG, New Taipei City (TW); Ching-Chi LIN, New Taipei City (TW)

(21) Appl. No.: 18/297,068

(22) Filed: Apr. 7, 2023

(30) Foreign Application Priority Data
Dec. 23, 2022 (TW) 111149627

(51) Int. Cl. H01Q 9/04

(52) U.S. Cl. CPC H01Q 9/0414; H01Q 9/0421

(57) ABSTRACT

A mobile device for reducing SAR (Specific Absorption Rate) includes a first radiation element, a second radiation element, a third radiation element, and a dielectric substrate. The first radiation element has a feeding point. The second radiation element is adjacent to the first radiation element. The second radiation element has a first notch region, a second notch region, and a third notch region. The second radiation element is coupled through the third radiation element to a ground voltage. The first radiation element, the second radiation element, and the third radiation element are disposed on the dielectric substrate. An antenna structure is formed the first radiation element, the second radiation element, and the third radiation element.

### CROSS REFERENCE TO RELATED APPLICATIONS

This application claims priority of Taiwan Patent Application No. 111149627 filed on Dec. 23, 2022, the entirety of which is incorporated by reference herein.

### BACKGROUND OF THE INVENTION

### Field of the Invention

The disclosure generally relates to a mobile device, and more particularly, it relates to a mobile device and an antenna structure therein.

### Description of the Related Art

With the advancements being made in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi and Bluetooth systems and using frequency bands of 2.4 GHz, 5.2 GHz, and 5.8 GHz.

An antenna is an indispensable component in a mobile device that supports wireless communication. However, the antenna is easily affected by adjacent metal components, which often interfere with the antenna and degrade the overall communication quality. Alternatively, the SAR (Specific Absorption Rate) may be too high to comply with regulations and laws. Accordingly, there is a need to propose a novel solution for solving the problems of the prior art.

### BRIEF SUMMARY OF THE INVENTION

In an exemplary embodiment, the disclosure is directed to a mobile device for reducing SAR (Specific Absorption Rate). The mobile device includes a first radiation element, a second radiation element, a third radiation element, and a dielectric substrate. The first radiation element has a feeding point. The second radiation element is adjacent to the first radiation element. The second radiation element has a first notch region, a second notch region, and a third notch region. The second radiation element is coupled through the third radiation element to a ground voltage. The first radiation element, the second radiation element, and the third radiation element are disposed on the dielectric substrate. An antenna structure is formed the first radiation element, the second radiation element, and the third radiation element.

In some embodiments, the first radiation element substantially has an L-shape. The second radiation element substantially has a straight-line shape. The third radiation element substantially has a relatively large rectangular shape. The width of the third radiation element is greater than the width of the second radiation element.

In some embodiments, each of the first notch region, the second notch region, and the third notch region substantially has a relatively small rectangular shape.

In some embodiments, the antenna structure covers a first frequency band, a second frequency band, and a third frequency band. The first frequency band is from 2400 MHz to 2500 MHz. The second frequency band is from 5150 MHz to 5850 MHz. The third frequency band is from 5925 MHz to 7125 MHz.

In some embodiments, the length of the first radiation element is substantially equal to 0.25 wavelength of the second frequency band.

In some embodiments, the length of the second radiation element is substantially equal to the wavelength of the third frequency band.

In some embodiments, the total length of the second radiation element and the third radiation element is substantially equal to 0.25 wavelength of the first frequency band.

In some embodiments, there is a first distance between the first notch region and the open end of the second radiation element. The first distance is substantially equal to 0.25 wavelength of the third frequency band.

In some embodiments, there is a second distance between the second notch region and the open end of the second radiation element. The second distance is substantially equal to 0.25 wavelength of the second frequency band.

In some embodiments, there is a third distance between the third notch region and the open end of the second radiation element. The third distance is substantially equal to 0.75 wavelength of the third frequency band.

### BRIEF DESCRIPTION OF DRAWINGS

The invention can be more fully understood by reading the subsequent detailed description and examples with references made to the accompanying drawings, wherein:

FIG. 1 is a top view of a mobile device according to an embodiment of the invention; and

FIG. 2 is a perspective view of a mobile device according to an embodiment of the invention.

### DETAILED DESCRIPTION OF THE INVENTION

In order to illustrate the purposes, features and advantages of the invention, the embodiments and figures of the invention are shown in detail below.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . .”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to other elements or features as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

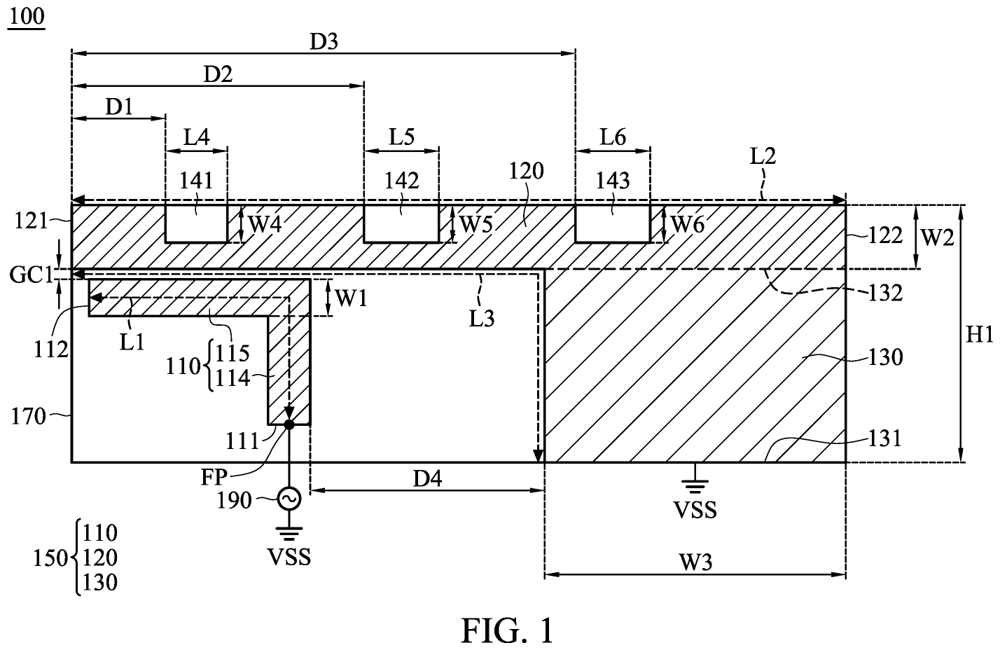

FIG. 1 is a top view of a mobile device 100 according to an embodiment of the invention. In the embodiment of FIG. 1, the mobile device 100 includes a first radiation element 110, a second radiation element 120, a third radiation element 130, and a dielectric substrate 170. The first radiation element 110, the second radiation element 120, and the third radiation element 130 may all be made of metal materials, such as copper, silver, aluminum, iron, or their alloys. It should be understood that the mobile device 100 may further include other components, such as a processor, a touch control panel, a speaker, a battery module, and a housing, although they are not displayed in FIG. 1.

The first radiation element 110 may substantially have an L-shape. Specifically, the first radiation element 110 has a first end 111 and a second end 112. A feeding point FP is positioned at the first end 111 of the first radiation element 110. The second end 112 of the first radiation element 110 is an open end. The feeding point FP may be further coupled to a signal source 190. For example, the signal source 190 may be an RF (Radio Frequency) module. In some embodiments, the first radiation element 110 includes a first portion 114 adjacent to the first end 111 and a second portion 115 adjacent to the second end 112. The second portion 115 is coupled through the first portion 114 to the feeding point FP. It should be noted that the term “adjacent” or “close” over the disclosure means that the distance (spacing) between two corresponding elements is smaller than a predetermined distance (e.g., 10 mm or shorter), or means that the two corresponding elements directly touch each other (i.e., the aforementioned distance/spacing therebetween is reduced to 0).

The second radiation element 120 may substantially have a straight-line shape, which may be substantially parallel to the second portion 115 of the first radiation element 110. Specifically, the second radiation element 120 has a first end 121 and a second end 122. The first end 121 of the second radiation element 120 is an open end. For example, the first end 121 of the second radiation element 120 and the second end 112 of the first radiation element 110 may substantially extend in the same direction. The second radiation element 120 is adjacent to the second portion 115 of the first radiation element 110. A coupling gap GC1 may be formed between the second portion 115 of the first radiation element 110 and the second radiation element 120. It should be noted that the second radiation element 120 has a first notch region 141, a second notch region 142, and a third notch region 143, which are independent of each other. In some embodiments, each of the first notch region 141, the second notch region 142, and the third notch region 143 substantially has a relatively small rectangular shape, but it is not limited thereto.

The third radiation element 130 may substantially have a relatively large rectangular shape or a relatively large square shape. Specifically, the third radiation element 130 has a first end 131 and a second end 132. The first end 131 of the third radiation element 130 is coupled to a ground voltage VSS. The second end 132 of the third radiation element 130 is coupled to the second end 122 of the second radiation element 120. Thus, the second radiation element 120 is coupled through the third radiation element 130 to the ground voltage VSS. For example, the ground voltage VSS may be provided by a system ground plane of the mobile device 100 (not shown), but it is not limited thereto. In some embodiments, the width W3 of the third radiation element 130 is greater than the width W2 of the second radiation element 120. For example, the aforementioned width W3 may be at least twice the aforementioned width W2.

The dielectric substrate 170 may be an FR4 (Flame Retardant 4) substrate, a PCB (Printed Circuit Board), or an FPC (Flexible Printed Circuit), but it is not limited thereto. In some embodiments, the first radiation element 110, the second radiation element 120, and the third radiation element 130 are all disposed on the same surface of the dielectric substrate 170.

In a preferred embodiment, an antenna structure 150 of the mobile device 100 is formed by the first radiation element 110, the second radiation element 120, and the third radiation element 130. In some embodiments, the antenna structure 150 is a planar antenna structure. However, the invention is not limited thereto. In alternative embodiments, the antenna structure 150 is modified to a 3D (Three Dimensional) antenna structure.

According to practical measurements, the antenna structure 150 of the mobile device 100 can cover a first frequency band, a second frequency band, and a third frequency band. For example, the first frequency band may be from 2400 MHz to 2500 MHz, the second frequency band may be from 5150 MHz to 5850 MHz, and the third frequency band may be from 5925 MHz to 7125 MHz, but they are not limited thereto. Accordingly, the antenna structure 150 of the mobile device 100 can support at least the wideband operations of conventional WLAN (Wireless Local Area Network) and next-generation Wi-Fi 6E.

In some embodiments, the operational principles of the antenna structure 150 of the mobile device 100 is described below. The second radiation element 120 and the third radiation element 130 can be excited by the first radiation element 110 using a coupling mechanism, so as to generate the first frequency band. The first radiation element 110 can be excited independently, so as to generate the second frequency band. The second radiation element 120 can be excited independently, so as to generate the third frequency band. In addition, according to practical measurements, the SAR (Specific Absorption Rate) of the antenna structure 150 of the mobile device 100 can be significantly reduced by 14% to 33% within the second frequency band and the third frequency band since the existences of the first notch region 141, the second notch region 142, and the third notch region 143 change the current distribution on the second radiation element 120 and decrease the current density thereof.

In some embodiments, the element sizes of the mobile device 100 are described below. The length L1 of the first radiation element 110 may be substantially equal to 0.25 wavelength (λ/4) of the second frequency band of the antenna structure 150 of the mobile device 100. The width W1 of the first radiation element 110 may be from 1 mm to 2 mm. The length L2 of the second radiation element 120 may be substantially equal to 1 wavelength (1λ) of the third frequency band of the antenna structure 150 of the mobile device 100. The width W2 of the second radiation element 120 may be from 2 mm to 3 mm. The total length L3 of the second radiation element 120 and the third radiation element 130 may be substantially equal to 0.25 wavelength (λ/4) of the first frequency band of the antenna structure 150 of the mobile device 100. The width W3 of the third radiation element 130 may be from 5 mm to 10 mm. The length L4 of the first notch region 141 may be from 2 mm to 3 mm. The width W4 of the first notch region 141 may be from 0.5 mm to 1.5 mm. There is a first distance D1 between the first notch region 141 and the first end 121 (open end) of the second radiation element 120. The first distance D1 may be substantially equal to 0.25 wavelength (λ/4) of the third frequency band of the antenna structure 150 of the mobile device 100. The length L5 of the second notch region 142 may be from 2 mm to 3 mm. The width W5 of the second notch region 142 may be from 0.5 mm to 1.5 mm. There is a second distance D2 between the second notch region 142 and the first end 121 (open end) of the second radiation element 120. The second distance D2 may be substantially equal to 0.25 wavelength (λ/4) of the second frequency band of the antenna structure 150 of the mobile device 100. The length L6 of the third notch region 143 may be from 2 mm to 3 mm. The width W6 of the third notch region 143 may be from 0.5 mm to 1.5 mm. There is a third distance D3 between the third notch region 143 and the first end 121 (open end) of the second radiation element 120. The third distance D3 may be substantially equal to 0.75 wavelength (3λ/4) of the third frequency band of the antenna structure 150 of the mobile device 100. There is a fourth distance D4 between the first portion 114 of the first radiation element 110 and the third radiation element 130. The fourth distance D4 may be from 5 mm to 15 mm. The width of the coupling gap GC1 may be shorter than or equal to 1 mm. The total height H1 of the antenna structure 150 may be shorter than or equal to 8 mm. The above ranges of element sizes are calculated and obtained according to the results of many experiments, and they help to optimize the SAR, the operational bandwidth, and the impedance matching of the antenna structure 150 of the mobile device 100.

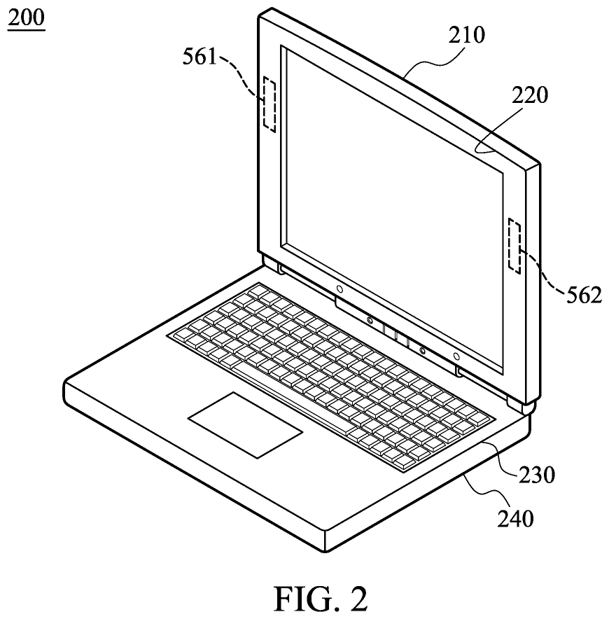

FIG. 2 is a perspective view of a mobile device 200 according to an embodiment of the invention. In the embodiment of FIG. 2, the mobile device 200 is a notebook computer and includes an upper cover housing 210, a display frame 220, a keyboard frame 230, and a base housing 240. It should be understood that the upper cover housing 210, the display frame 220, the keyboard frame 230, and the base housing 240 are equivalent to the so-called “A-component”, “B-component”, “C-component” and “D-component” in the field of notebook computers, respectively. The antenna structure 150 as described in the embodiment of FIG. 1 may be disposed at a first position 561 or a second position 562 adjacent to two sides of the display frame 220, but it is not limited thereto. According to practical measurements, such a design can help to minimize the SAR of the antenna structure 150 of the mobile device 200. In some embodiments, the mobile device 200 is implemented with a convertible mobile device. Other features of the mobile device 200 of FIG. 2 are similar to those of the mobile device 100 of FIG. 1. Accordingly, the two embodiments can achieve similar levels of performance.

The invention proposes a novel mobile device and its antenna structure. Compared to the conventional design, the invention has at least the advantages of low SAR, small size, wide bandwidth, low manufacturing cost, and good communication quality, and therefore it is suitable for application in a variety of mobile communication devices.

Note that the above element sizes, element shapes, and frequency ranges are not limitations of the invention. An antenna designer can fine-tune these settings or values according to different requirements. It should be understood that the mobile device and antenna structure of the invention are not limited to the configurations of FIGS. 1-2. The invention may merely include any one or more features of any one or more embodiments of FIGS. 1-2. In other words, not all of the features displayed in the figures should be implemented in the mobile device and antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device for reducing SAR (Specific Absorption Rate), comprising:
a first radiation element, having a feeding point;
a second radiation element, disposed adjacent to the first radiation element, wherein the second radiation element has a first notch region, a second notch region, and a third notch region;
a third radiation element, wherein the second radiation element is coupled through the third radiation element to a ground voltage; and
a dielectric substrate, wherein the first radiation element, the second radiation element, and the third radiation element are disposed on the dielectric substrate;
wherein an antenna structure is formed by the first radiation element, the second radiation element, and the third radiation element.

2. The mobile device as claimed in claim 1, wherein the first radiation element substatially has an L-shape.

3. The mobile device as claimed in claim 1, wherein the second radiation element substantially has a straight-line shape.

4. The mobile device as claimed in claim 1, wherein the third radiation element substantially has a relatively large rectangular shape.

5. The mobile device as claimed in claim 1, wherein a width of the third radiation element is greater than that of the second radiation element.

6. The mobile device as claimed in claim 1, wherein each of the first notch region, the second notch region, and the third notch region substantially has a relatively small rectangular shape.

7. The mobile device as claimed in claim 1, wherein the antenna structure covers a first frequency band, a second frequency band, and a third frequency band.

8. The mobile device as claimed in claim 7, wherein the first frequency band is from 2400 MHz to 2500 MHz, the second frequency band is from 5150 MHz to 5850 MHz, and the third frequency band is from 5925 MHz to 7125 MHz.

9. The mobile device as claimed in claim 7, wherein a length of the first radiation element is substantially equal to 0.25 wavelength of the second frequency band.

10. The mobile device as claimed in claim 7, wherein a length of the second radiation element is substantially equal to 1 wavelength of the third frequency band.

11. The mobile device as claimed in claim 7, wherein a total length of the second radiation element and the third radiation element is substantially equal to 0.25 wavelength of the first frequency band.

12. The mobile device as claimed in claim 7, wherein there is a first distance between the first notch region and an open end of the second radiation element, and the first distance is substantially equal to 0.25 wavelength of the third frequency band.

13. The mobile device as claimed in claim 7, wherein there is a second distance between the second notch region and an open end of the second radiation element, and the second distance is substantially equal to 0.25 wavelength of the second frequency band.

14. The mobile device as claimed in claim 7, wherein there is a third distance between the third notch region and an open end of the second radiation element, and the third distance is substantially equal to 0.75 wavelength of the third frequency band.

15. The mobile device as claimed in claim 1, wherein a total height of the antenna structure is shorter than or equal to 8 mm.
